(19) United States
(12) Patent Application Publication
(10) Pub. No.: US 2020/0255025 A1
(43) Pub. Date: Aug. 13, 2020

(54) MOTOR VEHICLE WITH A VEHICLE GUIDANCE SYSTEM, METHOD FOR OPERATING A VEHICLE GUIDANCE SYSTEM, AND COMPUTER PROGRAM

(71) Applicant: AUDI AG, Ingolstadt (DE)

(72) Inventor: Christian WRIEDT, Ingolstadt (DE)

(73) Assignee: AUDI AG, Ingolstadt (DE)

(21) Appl. No.: 16/755,997

(22) PCT Filed: Nov. 9, 2018
(86) PCT No.: PCT/EP2018/080742

§ 371 Date: Apr. 14, 2020

(30) Foreign Application Priority Data
Dec. 1, 2017 (DE) 10 2017 221 634.4

(51) Int. Cl. B60W 60/00; B60W 50/00

(52) U.S. Cl. CPC B60W 60/001; B60W 2555/60; B60W 50/0097

(57) ABSTRACT

A motor vehicle with a vehicle guidance system which is designed to guide the motor vehicle in an at least partly automated manner. The vehicle guidance system has a controller that ascertains output data to be used in order to actuate at least one actuator, which implements the at least partly automated operation of the motor vehicle, from input data, including sensor data of at least one sensor of the motor vehicle, wherein the controller has an inference unit with at least one probabilistic model which reproduces traffic rules, said model being designed to output traffic rule information, which relates to traffic rules to be taken into consideration and while ascertaining the output data, upon being provided with request data and evidence data, which is derived from the input data and relates to traffic rules, wherein each item of evidence data is assigned a degree of reliability.

### TECHNICAL FIELD

The present disclosure relates to a motor vehicle with a vehicle guidance system that is designed to guide the motor vehicle in an at least partly automated manner. The vehicle guidance system has a controller that ascertains output data to be used in order to actuate at least one actuator, which implements the at least partly automated operation of the motor vehicle, from input data, including sensor data of at least one sensor of the motor vehicle. The present disclosure also relates to a method for operating a vehicle guidance system and to a computer program.

### BACKGROUND

A current research area relates to the at least partially automatic guidance of motor vehicles, in particular the fully automatic guidance of motor vehicles, and consequently to autonomous operation. For this purpose, vehicle guidance systems have become known which can detect their own state by means of access to an environment detection, in particular by means of sensors, and determine and execute longitudinal and/or transverse guidance actions of the motor vehicle by actuation of appropriate actuators. Corresponding output data, which correspond to control commands for at least one actuator of the motor vehicle, are ultimately generated in the context of a comprehensive situation analysis, which is made the basis of a further driving strategy implemented by the output data.

In the context of this situation analysis or the determination of a driving strategy, substantial questions that are sometimes difficult to implement algorithmically in controllers arise. On the one hand, a motor vehicle that is at least partially automatically operated must comply with statutory provisions, i.e. traffic regulations, for example in Germany the provisions of the Road Traffic Act. This is currently implemented in corresponding vehicle guidance functions such that attributes, for example conflict zones and/or lane priorities, are extracted from procedural or object-oriented algorithms from an environment map enriched with current environmental data, in particular sensor data. Similar problems can also arise with regard to the prediction of the behavior of other road users, for example with regard to experience rules that describe typical behavior of such other road users. Result data from predictions can also be taken into consideration in the assessment of traffic rules to be taken into consideration based on legal regulations.

One problem with the existing processing of traffic rules, be it with regard to legal regulations and/or the experience-based assessment of the behavior of other road users, is that the reliability of data sources, for example sensor data and/or prediction units, cannot be automatically taken into consideration during processing. For example, typical measurement errors with regard to the sensor data are not reflected in the results finally obtained, unless complex error propagation is implemented within the algorithms. Another problem with the current implementation is the large number of traffic rules applicable in a traffic situation, which have to be taken into consideration, so that algorithms with complexity that are difficult to control arise.

### SUMMARY

The present disclosure is therefore based on the object of specifying a simplified implementation of the traffic control analysis that takes into consideration uncertainties of sensors and/or prediction units in at least partially automated vehicle guidance functions.

To solve this problem, the present disclosure provides in a motor vehicle of the type mentioned at the outset that the controller has an inference unit with at least one probabilistic model which reproduces traffic rules and comprises facts and inference rules, said model being designed to output traffic rule information, which relates to at least one traffic rule to be taken into consideration and which is taken into consideration while ascertaining the output data, upon being provided with request data and evidence data, which is derived from the input data and relates to traffic rules, wherein each item of evidence data is assigned a degree of reliability.

In the scope of the present disclosure, it was recognized that a direct transformation of traffic rules, in particular from laws, into facts and rules by means of the controller processing or the algorithms which implement the vehicle control function is possible when using a unit based on probabilistic-logic programming for inferring traffic rules at runtime of an automated driving function. The evidence data determined, for example, by sensors and/or prediction units at runtime of the vehicle guidance function can be transmitted to the inference unit in the form of evidence facts with associated probabilities of existence, that is to say reliabilities, and possibly distributions, where these evidence data are consistently taken into consideration in the inference and the quantification of the certainty of the derived statement about the provisions to be taken into consideration in the current traffic situation. The use of a probabilistic model with associated inference algorithms therefore initially enables the automatic consideration of uncertainties in sensors and prediction units without the need to develop special algorithms for this. The development of complex algorithms for the implementation of such information can be completely dispensed with, since the probabilistic-logical program is limited to a collection of formalized facts and rules. A further advantage of the use of the inference unit provided according to the present disclosure is the traceability that is still given due to the use of clear facts and inference rules, which can be lost both when using more complex algorithms and, for example, when using artificial intelligence, so that uncertainties can arise.

In some embodiments, for example, software components of the vehicle guidance function that are implemented in the controller can transmit request data to the inference unit, which determines the traffic control information using the current evidence data. Traffic rules can on the one hand reproduce legal regulations, it also being conceivable within the scope of the present disclosure to implement experience rules as traffic rules, for example to implement a prediction using the inference unit.

The facts and rules in probabilistic-logical programming form small, modular units of knowledge that can be combined in any way. The present disclosure therefore benefits from the declarativity of this type of programming and the search for a solution is carried out by the inference unit, not by an explicit algorithm which has to be developed in a complex manner. In addition to their clear comprehensibility and traceability, inference units of probabilistic programming are extremely robust, so that the traffic control information can be reliably determined.

The evidence data can include sensor data of at least one sensor, the assigned degree of reliability describing a measurement and/or evaluation error of the sensor data, and/or result data of a prediction unit of the controller, the assigned degree of reliability describing an algorithmic reliability of the prediction. As far as sensor data from the vehicle's own sensors are concerned, they are usually already pre-evaluated in order to obtain a corresponding evidence fact that describes the current traffic situation with a certain degree of reliability. In particular, sensor data from a plurality of sensors may have already been merged. The carrying out and further development of typical measurement errors is already known in principle and can be implemented/carried out accordingly during the evaluation.

This will be explained again in more concrete terms using an example that is kept simple for the demonstration. It is assumed that two other road users were recognized by an environment warning unit of the controller, which in particular fuses the sensor data of a large number of environment sensors, wherein the certainty that direction indicators of the two other road users are activated should be 0.5 and 0.9, respectively. In an example of probabilistic-logical programming, for which the syntax of the probabilistic-logical programming language Prob Log 2 is used, which is based on the predicate logic of the first level, this means for the corresponding evidence data:

0.5::blinker(road user 1).

0.9::blinker (road user 2).

From experience, for example from measurements, statistical surveys and/or machine learning, it can be known and, as a rule, stored in the probabilistic model that a road user whose direction indicator is actuated actually turns with a probability of 80%. In the example syntax above, this means as a rule of the probabilistic model:

0.8::turn(X):blinker(X).

If it is now to be determined which road users will turn in the current traffic situation, the following request can be made to the inference unit as request data in this greatly simplified example:

query(turn(road users)).

From this, the inference unit supplies the corresponding probabilities as traffic control information, namely for road user 1 that the probability of turning is 0.4, for road user 2 that the probability of turning is 0.72.

Other aspects of the inference situation interpretation can also concern traffic signs. For example, a traffic sign is relevant for the detection of a right of way. If, for example, with a probability of 0.86 a traffic sign indicating a priority road has been found at a specific position for a specific lane, corresponding evidence data can be formulated from this. A rule of the probabilistic model could indicate with a probability of 1.0 (since this always applies according to legal regulations) that your own motor vehicle has priority if your own position is in front of the position of the traffic sign and the appropriate lane is used.

These simple examples already show that especially combinable relationships can easily be mapped to corresponding rules and facts in a probabilistic model, which avoids complex, less efficient, robust and understandable algorithms. The inference unit can have an interpreter for a probabilistic programming language in which the model is described. A probabilistic programming language (often also probabilistic-logical programming language) that can be used is known, for example, under the name “Prob-Log 2.” The interpreter can already contain the inference algorithms, thus acting as an execution unit for requests.

As already mentioned, at least some of the traffic rules can include statutory regulations. In this context, embodiments of the present disclosure provide that a selection unit is provided which is designed to select a probabilistic model to be used from a plurality of probabilistic models assigned to geographical areas of application depending on a geographical position determined by a position determination unit. For example, the corresponding traffic regulations corresponding to legal regulations can be maintained as a probabilistic model within the motor vehicle for different countries, the suitable probabilistic model being selected depending on a specific geographical position, for example a GPS position, and used in the inference unit. The correct legal regulations are always taken into consideration by the at least partially automated vehicle guidance function.

As already mentioned, at least some of the traffic rules can also include experience rules, in which case at least one traffic rule information can be prediction information describing the future behavior of a road user. In this way, for example, prediction units that were previously provided can be replaced by requests to the probabilistic model, which can determine and deliver these predictions based on the experience rules themselves in a simply implemented manner.

Within the scope of the present disclosure, different hypotheses can also be taken into consideration, which for example can exist within an environment perception unit within an environment map with different probabilities, but which relate to the same circumstance. For example, it can be provided that at least some of the evidence data comprise different hypotheses for a circumstance described by them, each with associated reliability. For example, another road user can be assumed with a 70% probability that he is in the middle lane, with a 20% probability that he is in the right lane and with a 10% probability that he is located on the left lane. Using probabilistic-logical programming, it is possible to incorporate a plurality of such hypotheses into the evidence data as a discrete probability distribution and still take them into consideration correctly. In this way, it is no longer necessary to decide on one of the hypotheses regarding the circumstances, but the entire evaluation result can be taken into consideration and incorporated into the inference algorithm in order to provide more reliable, more accurate information.

In addition to the motor vehicle, the present disclosure also relates to a method for operating a vehicle guidance system of the motor vehicle, in particular of a motor vehicle according to the present disclosure, as described, wherein the vehicle guidance system has a controller that ascertains output data to be used in order to actuate at least one actuator, which implements the at least partly automated operation of the motor vehicle, from input data, including sensor data of at least one sensor of the motor vehicle, characterized in that the controller has an inference unit with at least one probabilistic model which reproduces traffic rules and comprises facts and inference rules, said model detecting traffic rule information, which relates to at least one traffic rule to be taken into consideration and which is taken into consideration while ascertaining the output data, upon being provided with request data and evidence data, which is derived from the input data and relates to traffic rules, wherein each item of evidence data is assigned a degree of reliability. All statements relating to the method according to the present disclosure can be analogously transferred to the method according to the present disclosure, with which, therefore, the already mentioned advantages can also be obtained.

The method according to the present disclosure can be implemented as a computer program which executes the steps of the method according to the present disclosure when it is executed on a control unit of a vehicle guidance system of a motor vehicle. The previous statements also apply accordingly with regard to the computer program.

### BRIEF DESCRIPTION OF THE DRAWINGS

Further advantages and details of the present disclosure will become apparent from the exemplary embodiments described below and with reference to the drawings. In the drawings:

FIG. 1 is a schematic diagram of an example motor vehicle according to embodiments of the present disclosure, and

FIG. 2 is a functional sketch of an example inference unit according to embodiments of the present disclosure.

### DETAILED DESCRIPTION

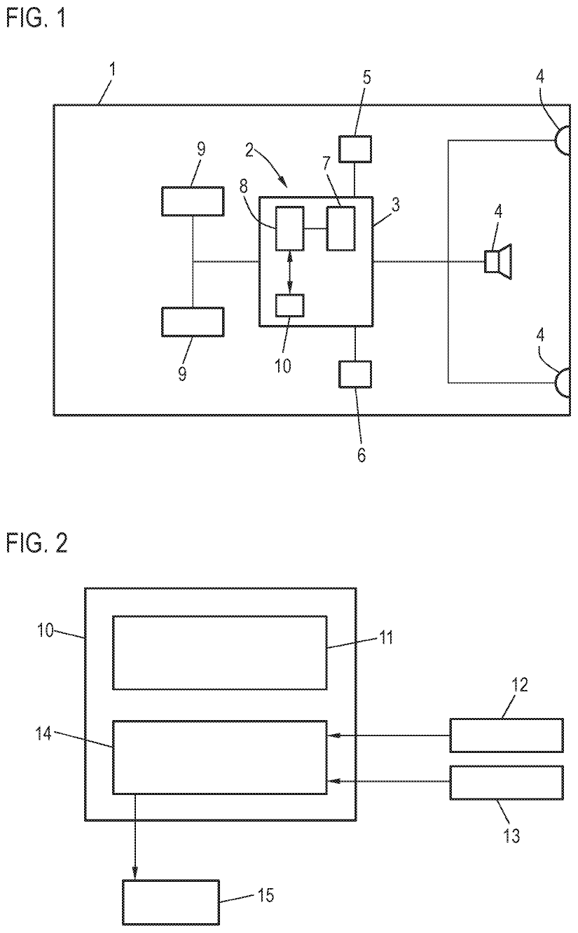

FIG. 1 shows a schematic diagram of a motor vehicle 1 according to example embodiments of the present disclosure. The motor vehicle 1 has a vehicle guidance system 2 which is designed to guide the motor vehicle 1 in an at least partly automated manner, in the present case in a completely automated manner, the vehicle guidance function of which is implemented by means of a controller 3. For this purpose, the controller 3 receives a large number of input data, environmental sensors 4, for example radar sensors and/or a camera, and operating sensors 5 which perceive the operating state of the motor vehicle 1, for example an inertial platform, as examples of sensors of the motor vehicle 1. A position determination unit 6 also provides further input data for determining a geographical, in particular geodetic, position of the motor vehicle 1, for example a GPS sensor.

Further sources for relevant input data can include, for example, a navigation system that supplies digital map data and/or a communication device in order to receive information from other motor vehicles and/or infrastructure devices.

In the present case, the controller 3 initially comprises an environment perception unit 7, in which the information obtained is expanded to an environment map, which can supplement a digital map with additional attributes that describe the current traffic situation, by merging incoming information, in particular sensor data from a plurality of sensors. An environment map determined in this way ultimately also forms input data for the vehicle control function. In the present case, this vehicle guidance function is implemented by a main unit 8 of the controller 3, which in particular comprises various software components. From the input data, the vehicle guidance function determines output data for actuating various actuators 9, which implement the at least partially automatic operation of the motor vehicle 1. The actuators 9 can be, for example, brake actuators, motors, steering actuators, and the like.

The controller 3 now also comprises an inference unit, to which software components of the vehicle guidance function can make requests that relate to traffic rules, including legal regulations and experience rules, whereby, for example, traffic control information about traffic rules to be observed can be obtained as well as prediction information about the behavior of other road users.

The inference unit 10 is implemented in probabilistic-logic programming, its functional structure being explained in more detail by FIG. 2. At least one probabilistic model 11, in which the traffic rules are described, is initially stored in the inference unit, for example that the motor vehicle 1 has right of way whenever a preceding right-of-way traffic sign that relates to the correct lane has been detected, in order to present a simplified example. The inference unit 10 receives, as input data, the already mentioned evidence data 12, which describe the current traffic situation and also assign a degree of reliability of these facts to the individual “facts,” for sensor data, for example, a corresponding measurement and evaluation error in relation to the pre-evaluation of the sensor data that has already taken place. For example, evidence data regarding a detected other road user can describe that there is a first probability on the right lane, a second probability on the middle lane and a third probability on the right lane, so that the evidence data 12 can therefore also cover a plurality of hypotheses. It should be noted that the evidence data 12 can also contain results from prediction units, to which a reliability value determined in the corresponding prediction algorithm can then be assigned as degree of reliability.

The inference unit 10 also receives request data 13, which describe which traffic control information is desired as a result. After the inference unit 10 now also has an interpreter 14, which implements the corresponding inference algorithms that are required, the desired traffic control information 15 can be generated using the probabilistic model 11 and the evidence data 12.

This traffic control information is then taken into consideration accordingly in the further determination of the output data, for example the planning of the next driving maneuvers.

Since the probabilistic model describes legal regulations as traffic rules that can be valid in different geographical areas, for example in different countries, different probabilistic models are stored in the controller 3 for these different validity areas, wherein a probabilistic model to be used based on a geographical position of the position determination unit 6 can be determined.

1-9. (canceled)

10. A motor vehicle comprising a vehicle guidance system configured to guide the motor vehicle in an at least partly automated manner, wherein the vehicle guidance system has a controller configured to determine output data based at least in part on input data, the output data to be used to actuate at least one actuator of the motor vehicle to implement at least in part the at least partly automated operation of the motor vehicle, wherein the input data comprises sensor data of at least one sensor of the motor vehicle;
wherein the controller comprises an inference unit having a probabilistic model configured to reproduce traffic rules, wherein the probabilistic model comprises facts and inference rules, wherein the inference unit is configured to:
receive request data and evidence data, wherein the evidence data is derived from the input data and relates to traffic rules, and wherein each item of the evidence data is assigned a degree of reliability; and
output traffic rule information based at least in part on the request data and the evidence data, the traffic rule information relating to at least one of the traffic rules being considered by the controller in determining the output data.

11. The motor vehicle according to claim 10, wherein the evidence data comprises sensor data of the at least one sensor of the motor vehicle, and wherein the assigned degree of reliability describes at least one of a measurement or evaluation error of the sensor data, and an algorithmic reliability of a prediction of a prediction unit of the controller.

12. The motor vehicle according to claim 10, wherein the inference unit comprises an interpreter for a probabilistic programming language in which the probabilistic model is described.

13. The motor vehicle according to claim 10, wherein the traffic regulations comprise statutory provisions.

14. The motor vehicle according to claim 13, wherein the controller further comprises a selection unit configured to select the probabilistic model from a plurality of probabilistic models assigned to geographical areas of application based at least in part on a geographical position of the motor vehicle, the geographic position being determined by a position determination unit of the motor vehicle.

15. The motor vehicle according to claim 10, wherein the traffic rules comprise at least one of experience rules and prediction information describing a future behavior of a road user.

16. The motor vehicle according to claim 10, wherein the evidence data comprises one or more hypotheses for a circumstance described by the evidence data, and wherein each hypothesis is assigned a degree of reliability.

17. A method for operating a vehicle guidance system of a motor vehicle, wherein the vehicle guidance system is configured to guide the motor vehicle in an at least partly automated manner, wherein the vehicle guidance system has a controller configured to determine output data based at least in part on input data, the output data being used to actuate at least one actuator of the motor vehicle to implement the at least partly automated operation of the motor vehicle, wherein the input data comprises sensor data of at least one sensor of the motor vehicle, wherein the controller comprises an inference unit having a probabilistic model configured to reproduce traffic rules, wherein the probabilistic model comprises facts and inference rules, the method comprising:
receiving, by the inference unit, request data and evidence data, wherein the evidence data is derived from the input data and relates to traffic rules, and wherein each item of evidence data is assigned a degree of reliability; and
outputting, by the inference unit, traffic rule information based at least in part on the request data and the evidence data the traffic rule information relating to at least one traffic rule being considered by the controller in determining the output data.

18. A tangible, non-transitory computer-readable media storing computer-readable instructions that when executed by one or more processors cause the one or more processors to perform operations for operating a vehicle guidance system of a motor vehicle, wherein the vehicle guidance system is configured to guide the motor vehicle in an at least partly automated manner, wherein the vehicle guidance system has a controller configured to determine output data based at least in part on input data, the output data to be used to actuate at least one actuator of the motor vehicle to implement the at least partly automated operation of the motor vehicle, wherein the input data comprises sensor data of at least one sensor of the motor vehicle, wherein the controller comprises an inference unit having a probabilistic model configured to reproduce traffic rules, wherein the probabilistic model comprises facts and inference rules, the operations comprising:
receiving, by the inference unit, request data and evidence data, wherein the evidence data is derived from the input data and relates to traffic rules, and wherein each item of the evidence data is assigned a degree of reliability; and
outputting, by the inference unit, traffic rule information based at least in part on the request data and the evidence data, the traffic rule information relating to at least one traffic rule being considered by the controller in determining the output data.
